(19) United States
(12) Patent Application Publication
(10) Pub. No.: US 2013/0074990 A1
(43) Pub. Date: Mar. 28, 2013

(54) ROLL ARRANGEMENT FOR A VENEER LATHE

(71) Applicant: Reijo SALOVAARA, Nastola (FI)

(72) Inventor: Reijo SALOVAARA, Nastola (FI)

(73) Assignee: RAUTE OYJ, Nastola (FI)

(21) Appl. No.: 13/627,006

(22) Filed: Sep. 26, 2012

(30) Foreign Application Priority Data
Sep. 26, 2011 (FI) 20115939

(51) Int. Cl. B27L 5/02

(52) U.S. Cl. 144/214

(57) ABSTRACT

A veneer lathe for peeling veneer from a log includes a first and a second support roll and a counter roll, all the rolls being parallel with the rotation axis of the log and having a length of substantially at least the length of the log. Each roll includes a shaft, with discs placed thereon having a width equaling to not more than the distance of the discs from each other in the longitudinal direction of the log. The discs have an outer diameter greater than that of their respective shaft and are concentric therewith. The discs of the second support roll and counter roll do not coincide in the longitudinal direction with the discs of the first support roll for enabling overlapping of the discs of the second support roll and the counter roll with the discs of the first support roll in the radial direction of the discs.

### FIELD OF THE INVENTION

The present invention relates to peeling veneer from a log. More precisely, the object of the invention is to enhance the peeling of veneer by using an apparatus with which a larger portion of the log is utilized, i.e. a much smaller log diameter is achieved at the end of the peeling.

### PRIOR ART

Conventionally, a veneer lathe is used for peeling veneer from a log, in a way that the log is rotatably supported from its ends between spindles of the lathe. The lathe carries a knife which extends along the length of the log and which is fed towards the rotation axis of the log while the log is rotated.

While being peeled in the lathe, the log is subjected to tremendous cutting forces, why the log is supported with one or more support rolls being in contact with the outer periphery of the log. Opposite to the knife, veneer lathes are also often equipped with a counter roll being in contact with the outer periphery of the log and the just detached veneer, so that the detached veneer runs between the counter roll and the knife.

Nested grippers for gripping the end faces of the log's ends are used at the ends of the lathe's spindles. For example, 2 to 3 grippers may be nested one within another, whereby the outer grippers retract out of the way of the knife and the knife carriage as the log's diameter diminishes. An outer diameter of a left over log from the peeling, i.e. a stub, equalling to the outer diameter of the innermost gripper+approximately 2 mm can be achieved in this way.

If the peeling is wished to continue further from this point, the innermost gripper may also be retracted, in which case the log remains fully supported and rotated by the support rolls and the counter roll. The rolls are conventionally supported at their ends. In such an arrangement the smallest achievable diameter of a log corresponds to a situation where the support rolls encounter the counter roll, each other of the knife carriage. Conventionally, the minimum diameter of a peeled log, i.e. a stub, is approximately 32 mm.

The large forces subjected to the log during veneer peeling result in that the support rolls and counter rolls have to be of a relatively massive construction. Additionally, reducing the size of the rolls results in a growth of surface pressure exerted on the log by the rolls, which may be undesirable. These factors prevent from achieving a smaller outer diameter of the stub by reducing the rolls.

For example, publication EP 0265310 (B1) discloses a spindleless veneer lathe where the log is supported and rotated by rolls during the whole peeling. In a conventional veneer lathe having spindles, the supporting of the log is somewhat similar towards the end of the peeling when the grippers have been retracted. The rolls in spindleless veneer lathes are typically subject to greater loads than in conventional veneer lathes due to e.g. the greater weight of the log in the beginning of the peeling. Thus, the size of the rolls has to be increased further at the expense of the minimum diameter of the stub.

### OBJECTS OF THE INVENTION

The object of the present invention is to provide a solution to overcome the drawbacks of the prior art and to provide an apparatus with which a smaller minimum diameter of a stub can be achieved.

In a solution according to the invention, the first and second support rolls and the counter roll comprise a shaft along the length of which discs are placed at a distance from each other, the discs having a width being not more than the distance of the discs from each other and the discs having an diameter greater than that of their corresponding shaft and being concentric with it, in such a way that the discs of the second support roll and the counter roll do not coincide with the discs of the first support roll in the length direction of the shaft for enabling radial overlapping of the discs of the second support roll and the counter roll with the discs of the first support roll.

In this way, the peeling can be continued until either one of the outer peripheries of the second support roll or the counter roll meets the bottom of the groove between discs in the first support roll. Thus, a better yield and a smaller stub is obtained from the log.

### BRIEF DESCRIPTION OF THE DRAWINGS

In the following the invention will be described in more detail with reference to the accompanying drawings in which;

FIG. 1 is a simplified elevational side view from an end of the log illustrating an initial phase of veneer peeling according to the invention.

FIG. 2 is a simplified elevational side view from the end of the log illustrating an end phase of veneer peeling according to the invention.

FIG. 3 is a simplified perspective view of the roll arrangement according to the invention

FIG. 4 is a more detailed side view from of the end of the log during the end phase of veneer peeling according to the invention.

### DETAILED DESCRIPTION OF THE INVENTION

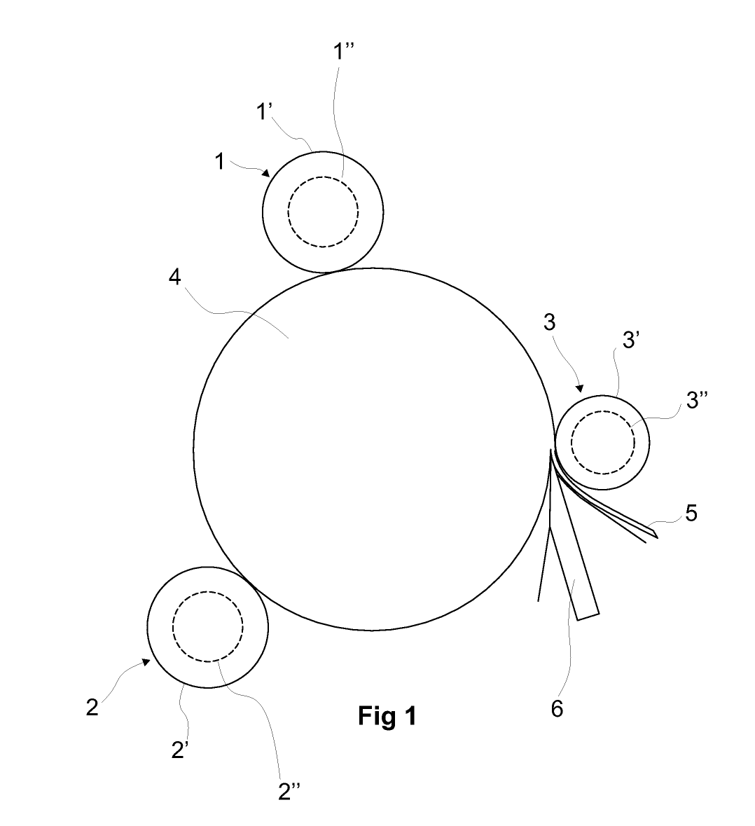

FIG. 1 shows a first support roll 1, a second support roll 2, a counter roll 3, and further discs 1′, 2′, 3′ located on their corresponding shafts 1″, 2″, 3″. In the situation of FIG. 1, the grippers (not shown) at the end of the veneer lathe's spindles have been retracted and the log 4 is supported between the support rolls 1, 2 and the counter roll 3 by the discs 1′, 2′, 3′. The knife 6 of the lathe peels veneer 5 from the log 4. For simplifying the drawings the veneer 5 is shown as a short tail, although in reality it is detached from the log 4 as a continuous web.

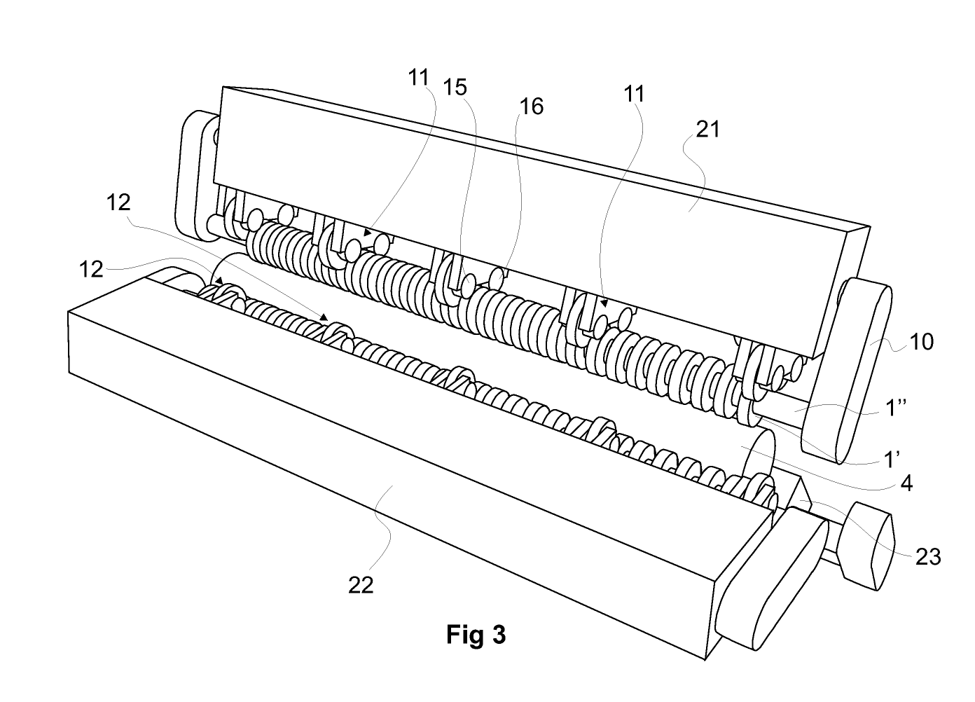

In the veneer lathe illustrated in FIG. 3, a roll arrangement according to one embodiment of the invention is shown. The first support roll is supported with a plurality of support bearings 11 and the second support roll is supported with a plurality of support bearings 12, which support bearings 11, 12 are located along the length of their corresponding rolls 1, 2. The counter roll and its similar support bearing arrangement 13 are hidden behind other elements illustrated in FIG. 3. The support bearings 11, 12, 13 of each roll 1, 2, 3 are located along the length of the log so that they are not aligned. Thus they do not coincide each other when the diameter of the log diminishes.

Either one or both of the support rolls 1,2 and the counter roll 3 can be rotated, for example by conventional electric or hydraulic motors, the rotational movement of which can be transmitted to the rolls by using conventional transmission methods. In the case of FIG. 3, the transmission for the rolls 1, 2, 3 is protected with a cover 10. The log can be rotated during the peeling by rotating the rolls.

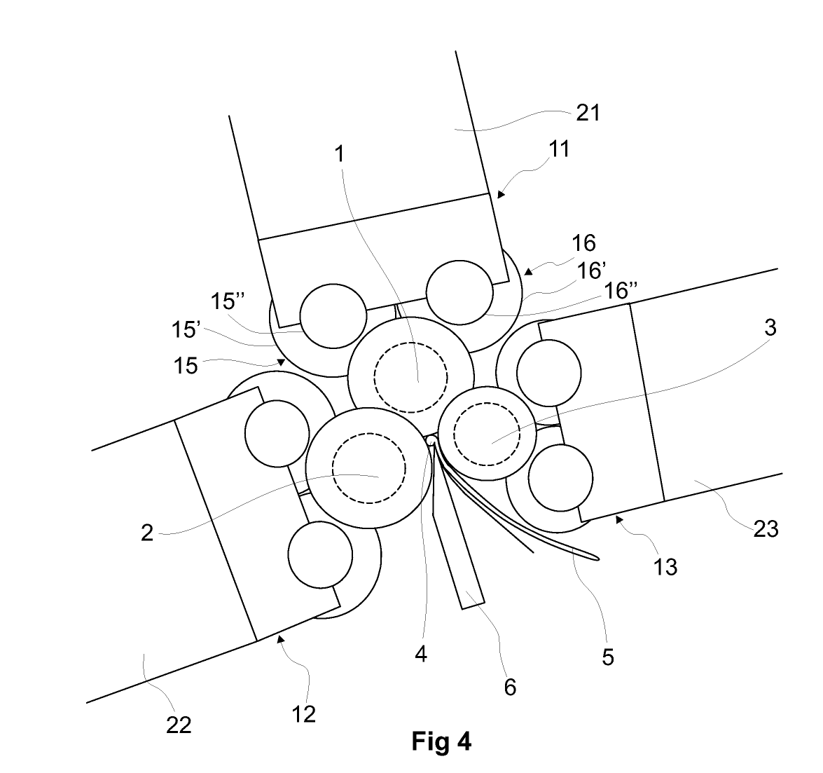

According to an embodiment of the invention, a supporting arrangement for the support rolls 1, 2 and the counter roll 3, in which arrangement each roll 1, 2, 3 is supported with a plurality of supporting bearings 11, 12, 13 correspondingly, as shown in FIG. 4 The corresponding support bearings 11, 12, 13 of each roll 1, 2, 3 are attached to bearing carriages 21, 22, 23 so that there is one bearing carriage for each roll as illustrated in FIG. 3. The bearing carriages are movable which is implemented in a known manner, for example by equipping them with actuators such as pneumatic or hydraulic cylinders, screw driven linear guides, etc. Preferably each of the rolls 1, 2, 3 can be moved separately by moving the support bearings of each roll. Each support bearing comprises two rotatably mounted support wheels 15, 16.

For a person skilled in the art it is obvious that the location, rotational speed, pressing force and other measures of the rolls, the knife and the actuators may be metered with suitable sensors, and that the information so gained may be utilized in controlling the veneer lathe during peeling.

In the situation illustrated in FIG. 1, the log 4 is detached from compression of the grippers at the ends of the veneer lathe's spindles. The discs 1′, 2′, 3′ of the support rolls 1, 2 and the counter roll 3 are in contact with the periphery of the log 4, thus supporting the it. The rolls 1, 2, 3 have a length being preferably of the same order as the length of the log 4 being peeled. One or more of the rolls 1, 2, 3 can be rotated in order to rotate the log. Simultaneously, as the peeling proceeds from the above mentioned situation and the diameter of the log diminishes, the rolls 1, 2, 3 are moved in such a way that they remain in contact with the log 4. As known in the art, also the knife 6 is moved during the peeling in order to ensure a desired thickness and quality of the veneer. To obtain a desired peeling result, also the distance between the knife 6 and the counter roll 3 may be adjusted.

According to the invention, a plurality of discs 1′, 2′, 3′ are located on the shafts of each roll 1, 2, 3, correspondingly. The discs are concentric with the shafts and are located at a distance from each other in the length direction of each shaft. The width of the discs should at most be equal to the distance of the discs from each other. Preferably, the width of the discs is just barely below this, in which case the surface pressure exerted on the log by the rolls is divided as evenly as possible.

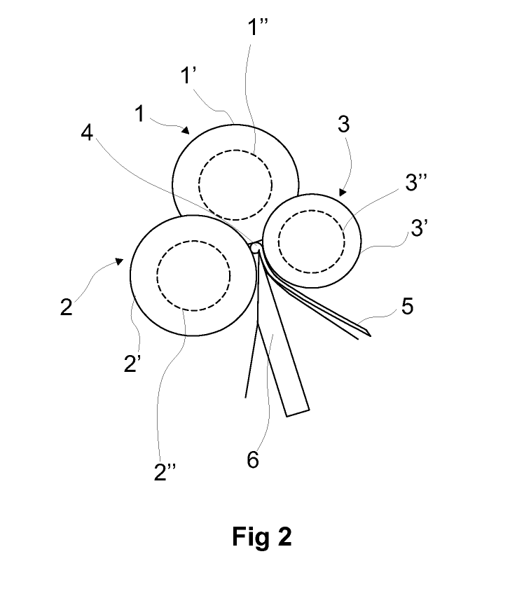

Essentially for the invention, the discs 2′, 3′, of the second support roll 2 and the counter roll 3 are located at different places in the longitudinal direction of the log than the discs 1′ of the first support roll 1. Thereby, a situation as illustrated in FIG. 2 can be accomplished, in which the discs 2′ of the second roll 2 and the discs 3′ of the counter roll 3 overlap with the discs 1′ of the first support roll 1 in the radial direction of the discs. This in turn allows the veneer peeling to be continued until the circumference 2′, 3′ of the second support roll 2 and of the counter roll 3 contacts the shaft 1″ of the first support roll 1, or vice versa. With the arrangement according to the invention, a minimum diameter of the stub in the order of 10 mm can be achieved.

According to an embodiment of the invention each roll 1, 2, 3 is supported at more than two points with support bearings 11, 12, 13, correspondingly. In such a case, each support bearing comprises at least two support wheels 15, 16, on the shafts 15″, 16″ of which discs 15′, 16′ are located, respectively. The width of the discs 15′, 16′ equals at most to the distance between the discs 1′, 2′, 3′ of each rolls 1, 2, 3. This kind of an arrangement provides good mechanical rigidity for the rolls 1, 2, 3.

According to another embodiment, each support bearing 11, 12, 13 is positioned relative to the roll 1, 2, 3 it supports so that discs 15′, 16′ of the support wheels do not coincide in the longitudinal direction of the log with the discs 1′, 2′, 3′, of the roll 1, 2, 3 supported by them. This means that the discs 15′, 16′ of the support wheels are placed between the discs 1′, 2′, 3′, of the rolls, which provides a good support for the rolls also in the axial direction, and additionally the space required by the support is reduced.

According to yet another embodiment, the shafts 15″, 16″ and discs 15′, 16′, of the support wheels of at least one roll 1, 2, 3 is dimensioned in such a way that the difference between their diameters is greater than the difference between the diameters of the shaft 1″, 2″, 3″ and discs 1′, 2′, 3′ of the roll supported by the corresponding support wheels. Such an arrangement allows the surface of the discs 1′, 2′, 3′, to be patterned for achieving a better grip between the rolls 1, 2, 3 and the log 4 without affecting the support of the rolls.

According to an alternative embodiment, the shafts 15″, 16″ and discs 15′, 16′, of the support wheels of at least one roll 1, 2, 3 is dimensioned in such a way that the difference between their diameters equals to the difference between the diameters of the shaft 1″, 2″, 3″ and discs 1′, 2′, 3′ of the roll supported by the corresponding support wheels. This leads to the advantage that each support bearing 11, 12, 13 supports the roll 1, 2, 3 both by the shaft 15″, 16″ and the discs 15′, 16′ of the support wheel.

Additionally, it should be noted that the rolls 1, 2, 3 do not need to be of the same size, but their diameters can be determined to be advantageous for the peeling process. For example, the counter roll 3 may advantageously be smaller that the support rolls 1, 2.

1. A veneer lathe for peeling veneer from a log (4), said veneer lathe comprising a first and a second support roll (1, 2) and a counter roll (3), the rolls (1, 2, 3) being parallel with the rotation axis of the log (4) and having a length of substantially at least the length of the log (4) to be peeled, characterized in that the first and second support roll (1, 2) and the counter roll (3) each comprise a shaft (1″, 2″, 3″) along the length of which discs (1′, 2′, 3′) are placed having a width equaling to not more than the distance of the discs (1′, 2′, 3′,) from each other in the longitudinal direction of the log (4), said discs (1′, 2′, 3′) having an outer diameter greater than the outer diameter of their respective shaft (1″, 2″, 3″) and said discs (1′, 2′, 3′) being concentric with their respective shaft (1″, 2″, 3″), in such a way that discs (2′, 3′) of the second support roll (2) and the counter roll (3) do not coincide in the longitudinal direction of the log (4) with the discs (1′) of the first support roll (1) for enabling overlapping of the discs (2′, 3′) of the second support roll (2) and the counter roll (3) with the discs (1′) of the first support roll (1) in the radial direction of the discs (2′, 3′).

2. A veneer lathe according to claim 1, characterized in that, at least one of the rolls (1, 2, 3,) is supported with more than one support bearing (11, 12, 13), said support bearings (11, 12, 13) being controllably movable towards and away from the log (4) for allowing independent movement of said at least one roll (1, 2, 3)

3. A veneer lathe according to claim 2, characterized in that each support bearing (11, 12, 13) comprises two rotatably mounted support wheels (15, 16), on the shafts (15″, 16″) of which two discs (15′, 16′) are arranged concentrically with said shafts (15″, 16″), said discs (15′, 16′) having a width at most equaling to the distance between the discs (1′, 2′, 3′) of the roll (1, 2, 3) supported by said support bearing (11, 12, 13) in the longitudinal direction of the log (4).

4. A veneer lathe according to claim 2, characterized in that the difference between the diameters of the discs (15′, 16′) and the shafts (15″, 16″) of the support wheels (15, 16) is greater than the difference between the diameters of the discs (1′, 2′, 3′,) and the shafts (1″, 2″, 3″) of the roll (1, 2, 3) supported by the respective support bearing (11, 12, 13).

5. A veneer lathe according to claim 2, characterized in that the difference between the diameters of the discs (15′, 16′) and the shafts (15″, 16″) of the support wheels (15, 16) equals to the difference between the diameters of the discs (1′, 2′, 3′,) and the shafts (1″, 2″, 3″) of the roll (1, 2, 3) supported by the respective support bearing (11, 12, 13).

6. A veneer lathe according to claim 3, characterized in that the difference between the diameters of the discs (15′, 16′) and the shafts (15″, 16″) of the support wheels (15, 16) is greater than the difference between the diameters of the discs (1′, 2′, 3′,) and the shafts (1″, 2″, 3″) of the roll (1, 2, 3) supported by the respective support bearing (11, 12, 13).

7. A veneer lathe according to claim 3, characterized in that the difference between the diameters of the discs (15′, 16′) and the shafts (15″, 16″) of the support wheels (15, 16) equals to the difference between the diameters of the discs (1′, 2′, 3′,) and the shafts (1″, 2″, 3″) of the roll (1, 2, 3) supported by the respective support bearing (11, 12, 13).
